(19) United States
(12) Patent Application Publication
(10) Pub. No.: US 2020/0111058 A1
(43) Pub. Date: Apr. 9, 2020

(54) SYSTEM AND METHODS FOR A GEOGRAPHICALLY BASED SCHEDULING SYSTEM

(71) Applicant: Jacob D. Blakeley, Phoenix, AZ (US)

(72) Inventor: Jacob D. Blakeley, Phoenix, AZ (US)

(21) Appl. No.: 16/154,053

(22) Filed: Oct. 8, 2018

(51) Int. Cl. G06Q 10/10; G06Q 10/06; G06Q 30/02; G06F 17/30

(52) U.S. Cl. CPC G06Q 10/1095; G06F 17/30241; G06Q 30/0205; G06Q 10/06311

(57) ABSTRACT

A system for providing a geographically based scheduling system includes a central processing system for receiving scheduling data from one or more service providers. The scheduling data includes an address where a service will be provided, a date of the scheduled service, and a geographic boundary area associated with the address. The central processing system interacts with a remote device to provide a list of available service providers to the remote device if a user's known geographic location is within the boundary area of the address where the service will be provided on the scheduled date of service. If a service provider is displayed to the remote device, the user is given the option to send a service request to the service provider for the date when the service provider will be at the address for the schedule service.

### BACKGROUND OF THE TECHNOLOGY

Residential service providers such as plumbers, electricians, cleaning services, mobile pet groomers, and the like often rely on traditional methods of advertising to target potential customers. These methods may include mailings, advertising in periodicals, using social media platforms, call centers to contact potential customers, and receiving recommendations from existing customers. Although each method has varying degrees of effectiveness, most of these methods rely on customers contacting the service provider to schedule a service. Other methods may suffer from reaching a potential customer when they are not currently in need of the particular service offered. As a result, service providers can spend a great deal of time and resources trying to get new service appointments.

Additionally, service providers who don't have the benefit of regular recurring appointments are often reliant on scheduling appointments based on when they are contacted by a customer. This method of scheduling appointments typically results in the service provider having to travel significant distances between scheduled appointments on a given day or risk losing an appointment if the service provider is unable to be at a particular location when it is convenient for the customer. This creates inefficiencies for the service provider due to factors such as increased travel time between jobs, increased fuel and maintenance costs for vehicles, increased labor rates for employees due to travel times between jobs, and increases in material waste resulting from tear down and set up for a given job.

### SUMMARY OF THE TECHNOLOGY

A system for providing a geographically based scheduling system includes a central processing system for receiving scheduling data from one or more service providers. The scheduling data includes an address where a service will be provided, a date of the scheduled service, and a geographic boundary area associated with the address. The central processing system interacts with a remote device to provide a list of available service providers to the remote device if a user's known geographic location is within the boundary area of the address where the service will be provided on the scheduled date of service. If a service provider is displayed to the remote device, the user is given the option to send a service request to the service provider for the date when the service provider will be at the address for the schedule service.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 is a block diagram of a scheduling system in accordance with an exemplary embodiment of the present technology;

FIG. 2 represents a user interface on a remote device in accordance with an exemplary embodiment of the present technology;

FIG. 3A illustrates a generic search result in accordance with an exemplary embodiment of the present technology;

FIG. 3B illustrates a first targeted search result in accordance with an exemplary embodiment of the present technology;

FIG. 3C illustrates a second targeted search result in accordance with an exemplary embodiment of the present technology;

FIG. 4A represents a first geographic boundary type set around a scheduled appointment in accordance with an exemplary embodiment of the present technology;

FIG. 4B represents a second geographic boundary type set around a scheduled appointment in accordance with an exemplary embodiment of the present technology;

FIG. 5 is a flowchart for uploading scheduling data in accordance with an exemplary embodiment of the present technology; and

FIG. 6 is a flowchart for accessing scheduling data in accordance with an exemplary embodiment of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

Various aspects of the present technology may be described in terms of functional block components and various processing steps. Such functional blocks may be realized by any number of mechanical, hardware, or software components configured to perform the specified functions and achieve the various results. For example, exemplary embodiments of the present technology may be used in conjunction with mobile devices, wireless devices, user interfaces, communication systems, open source software applications, social media platforms, shard or decentralized electronic files, and the like. In addition, various aspects of the present technology may be practiced in conjunction with any number of scheduling systems, messaging applications, payment systems, or any number of processes such as wireless communication, communication over the internet, and data transfer, and the systems and methods described are merely exemplary applications for the technology. Further, exemplary embodiments of the present technology may employ any number of conventional techniques for communication, encryption, and the like.

Methods and apparatus for a geographically based scheduling system according to various aspects of the present technology may operate in conjunction with any type of personal computing device configured to communicate over a network such as the Internet or broadband mobile communication network. Various representative implementations of the disclosed technology may be applied to any portable or stationary computing device capable of capturing and receiving user inputs, displaying calendar data, recording and/or playing audio and video, and providing location information.

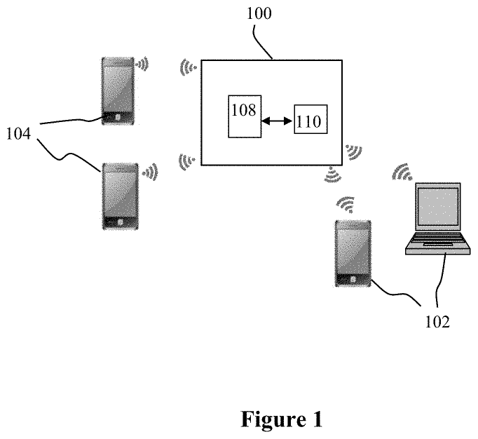

For example, referring to FIG. 1, a scheduling system 100 is configured to receive scheduling data for service appointments from one or more service providers 102 and provide the scheduling data to one or more remote user devices 104 over a communication network. The scheduling system 100 may comprise a central processing system 108 communicatively linked to a scheduling database 110 that is configured to store the received scheduling data.

The central processing system 108 stores and processes the scheduling data to facilitate the scheduling of services by potential customers according to their location relative to one or more preexisting scheduled service appointments. The central processing system 108 may comprise any suitable system or device such as a computer server or a cloud-based application server for communicating with remote computing devices, storing data files and/or application programs, and facilitating the transfer of scheduling data between multiple users.

The central processing system 108 may also be configured to provide an application program for distribution to the remote device(s) 104. The application program may comprise a set of computer implemented instructions for causing a remote connection system to be installed on the remote device 104 to enable the remote device 104 to communicate with the central processing system 108.

The central processing system 108 may also be configured to store scheduling data and/or allow controlled access to the stored scheduling data. The central processing system 108 may communicate the scheduling data to the remote device 104 in a format consistent with other services or applications such as a calendar application included on computing platforms or mobile devices. For example, the central processing system 108 may be configured to receive scheduling data for service appointments from one or more service providers 102. The central processing system 108 may then save the scheduling data to the scheduling database 110. In response to a query from the remote device 104, the central processing system 108 may provide the remote device 104 with access to any scheduling data that matches the query or the central processing system 108 may communicate the scheduling data to the remote device 104. The central processing system 108 may format the scheduling data for use by a calendar application that can be accessed by or is installed on the remote device 104.

The central processing system 108 may comprise a contractor module for allowing service providers/contractors to upload scheduling data for service appointments. The contractor module may include profile data for each service provider/contractor that includes information such as: name, address, website information, contact information, employee data, and examples of previous work. The contractor module may also link each service provider's set of profile data to additional sources of data relating to the service provider such as reviews from third party websites.

The central processing system 108 may also comprise a customer module for allowing customers to create an account and access the stored scheduling data. The customer module may include a set of customer profile data for each user that includes information such as: customer name, customer address, and contact information.

The central processing system 108 may also comprise an application delivery system may configured to install the application program on the remote device 104. The application delivery system may comprise any suitable system or method for allowing the remote device 104 to install application programs. In one embodiment, the application delivery system may comprise a virtual storefront adapted to allow users to select a desired application program for use on their respective remote device 104. For example, the user may be able to access the virtual storefront through the internet by using the remote device 104 to connect to the application delivery system via the communication system. The user may then select the application program and have the selected application program delivered to the remote device 104 over the communication system. Alternatively, the application program may be made available to users over an online storefront that provides access to various software applications for a particular platform or operating system such as iOS or Android®.

The scheduling system 100 may also comprise a social media network to provide a conduit for multiple users/customers to interact with one or more service providers/contractors to schedule services in a geographically based manner based on preexisting scheduled appointments. The social media network may comprise any suitable method or system allowing multiple users to interact. The social media network may comprise a public or private network utilizing web based and mobile technologies to facilitate information exchange between users or the social media network may be configured to be integrated into or otherwise function within a preexisting social media network. For example, the central processing system 108 may allow the remote device 104 to send and/or receive information from the social media network. In one embodiment, the central processing system 108 may be integrated into a first social media site and be suitably configured to communicate information received from the remote device 104 to a second social media site and/or communicate information from the second social media site to the remote device 104. In alternative embodiment, the remote device 104 may be configured to send or receive information directly to the second social media site.

The scheduling database 110 stores information that is either received or created by the processing system 108, the contractor module, and/or the customer module. The scheduling database 110 may comprise any suitable memory system such as a hard disc drive, flash memory, removable media card, or some combination of multiple types of memory. The scheduling database 110 may be configured to either permanently or temporarily store data in response to a command from the central processing system 108.

The remote connection system enables the remote device 104 to access the central processing system 108 to obtain scheduling data and contact the corresponding service providers/contractors. In one embodiment, the remote connection system may comprise a set of computer readable instructions for causing the remote device 104 to respond to various user inputs. For example, the remote connection system may comprise a software application system adapted for installation on the remote device 104. The remote connection system may further enable the remote device 104 to communicate with the central processing system 108 either directly or through the social media network.

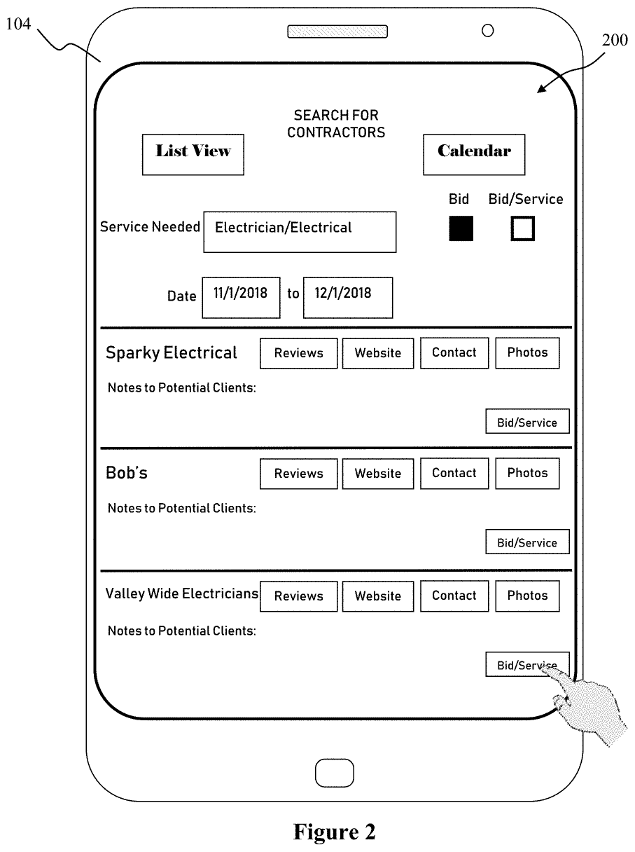

Referring now to FIG. 2, the remote connection system may be suitably configured to display a graphical user interface (GUI) 200 on a screen of the remote device 104 that is adapted to guide the user through accessing the scheduling data. In response to a command to view a list of service providers 102 that that are located within proximity to an address associated with the customer's profile or account, the GUI may prompt the user to a set of search criteria. For example, the user may be prompted to select a type of service and/or a date range. The GUI 200 may include one or more entry fields to allow the user to customize the scope of a desired search for service providers 102 that are already scheduled to be near the user's location. In one embodiment, the user interface 200 may include entry fields where the customer can enter or select a desired type of service and a date range. For example, if the user wants to see if any electricians will be near them during the month of November, the user may select electricians from a menu or type in the entry and then specify the desired date range in the appropriate field.

The remote connection system is configured to forward the received inputs to the central processing system 108 and in return receive some portion of the stored scheduling data that corresponds to both the user's search criteria and saved scheduled appointments that have a geographic boundary that includes the user's address. The central processing system 108 is configured to identify only those service providers 102 with a preexisting scheduled service appointment where the user is located within a predetermined geographic boundary set around the preexisting scheduled service appointment by the service providers 102. Identified service providers 102 that match the search criteria are then communicated back to the remote device 104.

The remote connection system may display the identified service providers 102 returned from the central processing system 108 to the user by any suitable method such as a list or graphically. For example, in one embodiment, the GUI 200 may include one or more buttons that allow the user to choose how the results are displayed. If the “List View” option is selected, then the results of the service providers 102 that meet the user's search criteria will be presented in a scrollable list.

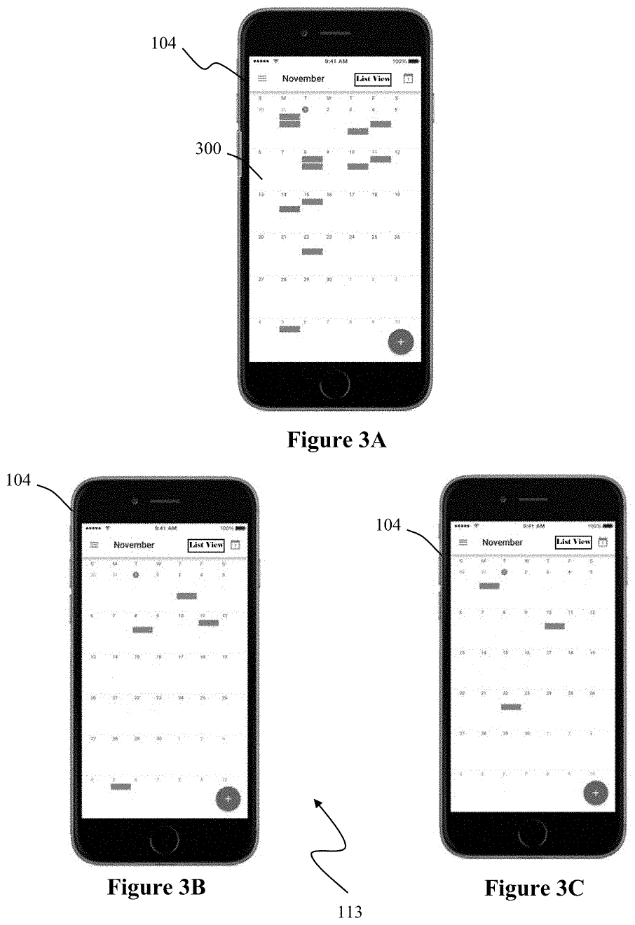

Referring now to FIGS. 3A-3C, if the “Calendar View” option is selected, then the identified service providers 102 that meet the user's search criteria will be presented in a calendar format. Scheduled service appointments matching the search request will be shown on the corresponding calendar days. For example, referring now to FIG. 3A, if the user selects a date range from Nov. 1, 2018 to Dec. 1, 2018 and leaves the service type blank, then the central processing system 108 may return all service providers 102 that are scheduled to be in the user's vicinity (as determined by the geographic boundary set by the service provider 102) for the selected date range. Each scheduled service appointment will be shown and the user may select a given service provider 102 to obtain more information on that particular service provider 102 or to request a service appointment.

If the user enters a particular type of service in the search query, then the central processing system 108 may return only those service providers 102 that offer that type of service and already have service appointments scheduled near the user. For example, referring now to FIG. 3B, if the user selected electricians and the date range of Nov. 1, 2018 to Dec. 1, 2018, then GUI 200 will only show electricians that have scheduled service appointments where the user is located within the predetermined geographic boundary. Similarly, and referring now to FIG. 3C, if the user selected cleaning services with the date range of Nov. 1, 2018 to Dec. 1, 2018, then GUI 200 would only show those service providers 102 that offer cleaning services that have scheduled service appointments where the user is located within the predetermined geographic boundary.

The remote connection system may also be configured to allow the user to submit a review for any service provider 102 that the user has received service from. For example, the GUI 200 may include a selectable option that allows the user to submit a review. Alternatively, after a service has been performed, the central processing system 108 may sent a notice to the remote device prompting the user to submit a review for the service provider 102 that was used to provide the service.

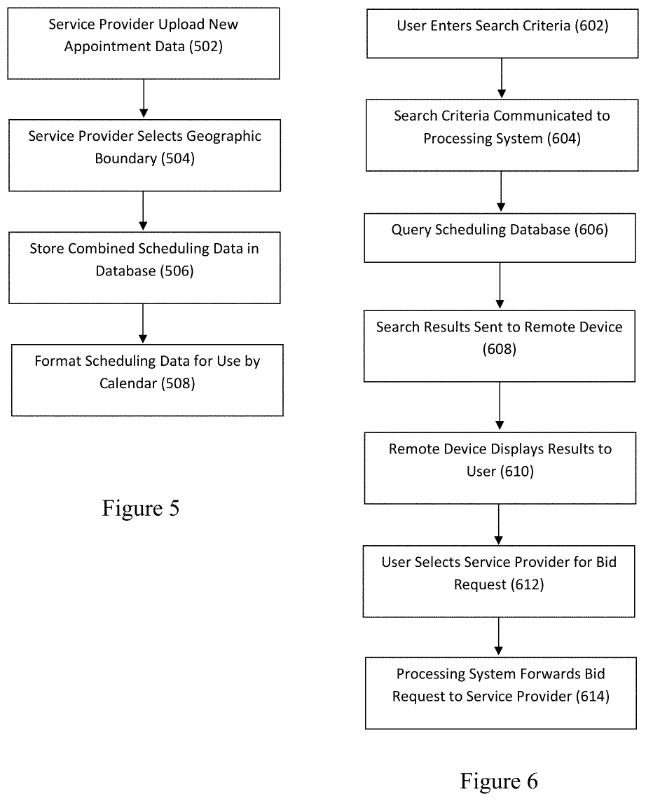

Referring now to FIG. 5, in operation, a service provider 102 may access their contractor profile stored on the scheduling database 110 and upload new scheduling data (502). The scheduling data may include one or more scheduled service appointments, wherein each scheduled service appointment includes a date of the service appointment and an address where the service will be performed. The central processing system 108 may recognize each newly scheduled service appointment and prompt the service provider 102 to submit a geographic boundary limit to associate with the address where the service will be performed (504). Alternatively, the service provider 102 may supply the geographic boundary as part of the original scheduling data that is uploaded to the central processing system 108.

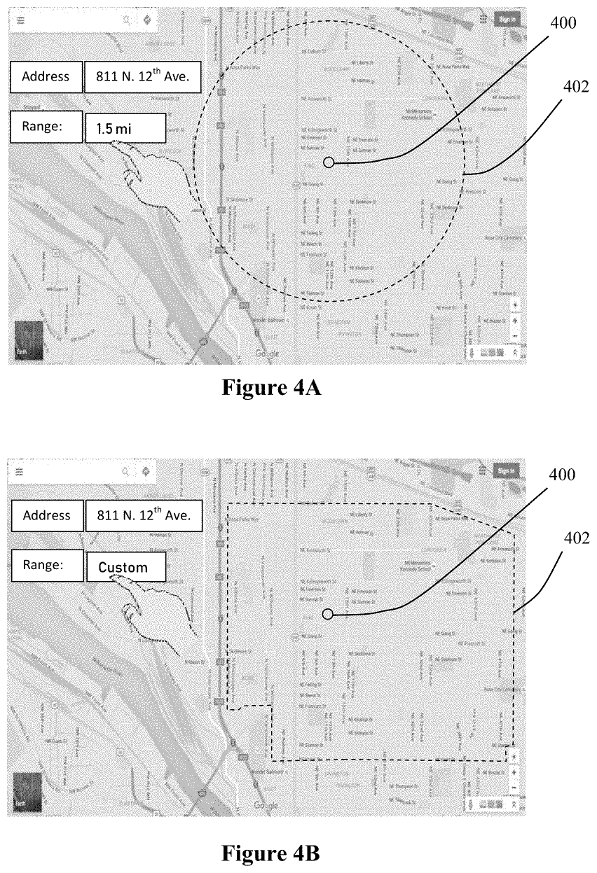

For example, referring now to FIG. 4A, in one embodiment, after receiving the uploaded scheduling data, the central processing system 108 may display an address 400 for a given scheduled appointment on a map and prompt the service provider 102 to select or otherwise identify a geographic boundary 402 around the address 400. The service provider 102 may be able to select from a predetermined range or specify a particular radius around the address 400. For example, the service provider 102 may select a circular geographic boundary 402 from a set of predetermined radiuses such as: ½ mile, ¾ mile, 1 mile, 1.5 miles, and 2 miles. Alternatively, and referring now to FIG. 4B, the service provider 102 may be able to define a custom geographic boundary 402 around the address 400 in the event that the service provider 102 wants to limit the boundary area 402 to a specific region, neighborhood, or area of the city/town, etc.

Referring again to FIG. 5, the central processing system 108 may then associate the selected geographic boundary 402 with the scheduling data and store the combined data in the scheduling database (506). The stored scheduling data may then be formatted for use by a calendar application and/or the remote devices 104 (508).

The central processing system 108 may also be configured to help identify preexisting customers located near a newly uploaded scheduled appointment. For example, after the geographic boundary 402 has been set by the service provider 102, the central processing system 108 may provide an indication to the service provider 102 of prior customers that are located within the geographic boundary 402. Alternatively, the service provider 102 may be able to run a search of the geographic boundary 402 to determine if there are any previous customers of the service provider 102 located within the geographic boundary 402.

The central processing system 108 may allow the service provider 102 to send a notification to one or more of the identified prior customers that the service provider 102 will be in their area on a given date and is accepting service requests. For example, the service provider 102 may be able to send a message to the prior customer(s) that includes a discount for service on that date that the service provider 102 is scheduled to be at the newly uploaded scheduled service appointment. This feature may allow the service provider 102 to schedule additional appointments in the area around a new appointment to create a more efficient workload for the service provider 102.

Referring now to FIGS. 2 and 6, a customer may launch a remote connection system on their remote device 104 to access the central processing system 108. The GUI 200 may be presented to the customer on the remote device 104 to allow the customer to view a list of scheduled service appointments that are located within proximity to an address associated with the customer's profile or account. For example, the GUI 200 may include one or more entry fields to allow the customer to customize the scope of a desired search for service providers 102 that are already scheduled to be near the customer's location (602). In one embodiment, the GUI 200 may include entry fields where the customer can enter or select a desired type of service and a date range. For example, if the customer wants to see if any electricians will be near them during the month of November, the customer may select electricians from a menu or type in the entry and then specify the desired date range. The remote connection system may forward or otherwise communicate this information to the central processing system 108 as a set of search criteria (604).

The central processing system 108 may combine the set of search criteria with a known address for the customer and perform a query of the scheduling database to identify whether or not there are any service providers 102 that have scheduled service appointments that meet the search criteria (606) and the requirements relating to the geographic boundary set by the service provider 102. Any scheduled appointments saved within the scheduling database that correspond to the search query may then be communicated back to the remote device 104 (608).

The search results received by the remote device 104 may be displayed to the customer by any suitable method. For example, the customer may select between a list view of the search results or have the results displayed on a calendar system resident on the remote device 104 (610). The customer may then review the service provider(s) 102 presented in the results by selecting one or more options presented on the results screen. For example, and referring again to FIG. 2, the GUI 200 may provide links for each listed service provider 102 that correspond to detailed information about the service provider 102, reviews about the service provider 102, contact information, a link to the service provider's 102 website, pictures of the service provider's 102 work or employees, or any other like information.

The GUI 200 may also include a method for allowing the customer to submit a request for service to the service provider 102 (612). For example, the GUI 200 may include a link configured to send a message to the service provider 102 that a potential customer near an already scheduled service appointment is requesting service on the same day as the scheduled service appointment (614). Upon receipt of the message, the central processing system 108 may allow the service provider 102 to reply to the customer with one or more options to schedule an appointment or the service provider 102 may be provided with the customer's contact information so that the service provider 102 can contact the customer directly.

These and other embodiments for methods of providing a scheduling system may incorporate concepts, embodiments, and configurations as described above. The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the components and/or elements recited in any apparatus embodiment may be assembled or otherwise operationally configured in a variety of permutations to produce substantially the same result as the present technology and are accordingly not limited to the specific configuration recited in the specific examples.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology, as expressed in the following claims.

1. A method for scheduling appointments, comprising:
receiving by a central processing system scheduled appointment data from a plurality of service providers, wherein the scheduled appointment data for each appointment comprises:
a name of the service provider;
a service type;
a scheduled appointment date;
an address for the scheduled appointment date; and
a geographic boundary around the address;
providing access to the scheduled appointment data to a remote device;
receiving, by the central processing system, a set of search criteria from the remote device;
displaying a portion of the scheduled appointment data for the plurality of service providers to the remote device if an address associated with the remote device is determined to be within the geographic boundary around the address for the scheduled appointment date; and
allowing the remote device to send an appointment request to at least one service provider via the central processor for the scheduled appointment date.

2. A method for scheduling appointments according to claim 1, wherein displaying the scheduled appoint data comprises:
displaying all service providers meeting the set of search criteria; and
formatting the displayed scheduled appointment data for viewing on a calendar application displayed on the remote device.

3. A method for scheduling appointments according to claim 1, wherein the set of search criteria comprises:
a selected service type; and
a date range.

4. A method for scheduling appointments according to claim 1, further comprising receiving by the central processing system a set of profile data for each service provider.

5. A method for scheduling appointments according to claim 4, wherein the central processing system is configured to display the set of profile data to the remote device in response to a request from the remote device.

6. A method for scheduling appointments according to claim 4, wherein the central processing system is configured to add a customer review received from the remote device to the contractor profile.

7. A method for scheduling appointments according to claim 1, wherein the geographic boundary around the address for each scheduled appointment date may be selected by the corresponding contractor.

8. A method for scheduling appointments according to claim 1, further comprising:
allowing a contractor from the plurality of contractors to search within the geographic boundary around the address for a scheduled appointment date to identify any preexisting customers of the contractor; and
pushing a notification to the preexisting customers that the contractor will be near their location on the scheduled appointment date.

9. A method for scheduling appointments according to claim 8, wherein the notification is sent in response to an instruction from the contractor.

10. A method for scheduling appointments according to claim 1, further comprising transmitting messages between an individual service provider and the remote device via a messaging application linked to the central processing system.

11. A system for allowing a customer to schedule appointments from a plurality of service providers using a remote device, comprising:
an application server, comprising:
a central processing system configured to receive scheduled appointment data from a plurality of service providers, wherein the scheduled appointment data received from each service provider comprises:
a name of the service provider;
a service type;
a scheduled appointment date;
an address for the scheduled appointment date; and
a geographic boundary around the address;
a scheduling database communicatively linked to the central processing system and configured to store the received scheduled appointment data;
a remote connection system installed on the remote device and configured to:
access the central processing system to query the stored scheduled appointment data according to a set of search criteria;
receive at least a portion of the stored scheduled appointment data matching the set of search criteria; and
display the received scheduled appointment data on a calendar application resident on the remote device if the remote device is determined to be within the geographic boundary around the address for the scheduled appointment date.

12. A system for allowing a customer to schedule appointments according to claim 11, wherein the central processor is configured to:
receive an appointment request from the remote device for at least one service provider; and
forward the appointment request to the at least one service provider.

13. A system for allowing a customer to schedule appointments according to claim 11, wherein the application server further comprises:
a contractor module configured to:
collect and store contractor profile data on the scheduling database; and
collect and store scheduled appointment data on the scheduling database; and
a user module configured to store a user profile on the scheduling database.

14. A system for allowing a customer to schedule appointments according to claim 11, wherein the set of search criteria comprises:
a selected service type; and
a date range.

15. A system for allowing a customer to schedule appointments according to claim 11, wherein the central processing system comprises a contractor profile for each of the plurality of service providers.

16. A system for allowing a customer to schedule appointments according to claim 15, wherein the central processing system is configured to display the contractor profile to the remote device in response to a request from the remote device.

17. A system for allowing a customer to schedule appointments according to claim 15, wherein the central processing system is configured to add a customer review received from the remote device to the contractor profile.

18. A system for allowing a customer to schedule appointments according to claim 11, wherein the geographic boundary around the address for each scheduled appointment date may be selected by the corresponding service provider.

19. A system for allowing a customer to schedule appointments according to claim 11, wherein the central processor is further configured to:
allow a service provider from the plurality of service providers to search within the geographic boundary around the address for a scheduled appointment date to identify any preexisting customers of the service provider; and
push a notification, in response to an instruction from the service provider, to one or more of the preexisting customers that the service provider will be near their location on the scheduled appointment date.

20. A system for allowing a customer to schedule appointments according to claim 11, wherein the central processing system is configured to transmit messages between an individual service provider and the remote device via a messaging application linked to the central processing system.
